(19) United States
(12) Patent Application Publication
(10) Pub. No.: US 2013/0324405 A1
(43) Pub. Date: Dec. 5, 2013

(54) NEW ANTIFUNGAL COMPOSITIONS

(71) Applicants: Jacobus Stark, Echt (NL); Angelique De Rijk, Echt (NL)

(72) Inventors: Jacobus Stark, Echt (NL); Angelique De Rijk, Echt (NL)

(73) Assignee: DSM IP ASSETS B.V., Heerlen (NL)

(21) Appl. No.: 13/985,406

(22) PCT Filed: Mar. 1, 2012
(86) PCT No.: PCT/EP2012/053516

§ 371 Date: Aug. 14, 2013

(30) Foreign Application Priority Data
Mar. 3, 2011 (EP) 11156778.0

(51) Int. Cl. A01N 43/90; A01N 43/707; A01N 47/38; A01N 51/00; A01N 43/50

(52) U.S. Cl. CPC A01N 43/90; A01N 51/00; A01N 43/50; A01N 47/38; A01N 43/707
USPC 504/116.1; 514/31

(57) ABSTRACT

The present invention relates to new antifungal compositions and their use in the treatment of agricultural products.

### FIELD OF THE INVENTION

The present invention discloses new antimicrobial compositions to control plant diseases and to prevent microbial spoilage of crops.

### BACKGROUND OF THE INVENTION

It is estimated that about 25% of the world crop production is lost due to microbial spoilage, of which spoilage by fungi is by far the most important cause. Not only from an economical point of view, but also from a humane point of view it is of great importance to prevent spoilage of food products. After all, in many parts of the world people suffer from hunger.

Success in combating plant and crop diseases and in reducing the damage they cause to yields and quality depends greatly on the timely application of fungicides. The prolonged and frequent use of many fungicides such as e.g. benzamidazoles has contributed to reduce their effectiveness thanks to the development of phenomena of resistance.

An important new class of fungicides are the imidazoles. The most well known imidazole fungicide is fenamidone (also called RPA 407213; see Mercer et al. 1998). At the biochemical level, fenamidone inhibits mitochondrial respiration by blocking electron transport at the level of enzyme ubihydroquinone:cytochrome c oxidoreductase. Fenamidone was developed by Aventis CropScience and was first sold in 2001.

Another well known imidazole is imazalil. In EP 0 101 102 A2 a method for protecting food products from fungal decay is described wherein food products are packaged in a film comprising imazalil. EP 0 748 588 A1 discloses polyvinylacetate coatings comprising natamycin and imazalil and their use in protecting cheese against fungal growth.

Although the imidazole fungicides have shown activity against fungi (see Mercer et al. 1998), spoilage problems still occur. Moreover, several studies have shown that more and more fungi acquire resistance against these fungicides (see e.g. Kardin and Percich, 1983).

For many decades, the polyene macrolide antimycotic natamycin has been used to prevent fungal growth on food products such as cheeses and sausages. This natural preservative, which is produced by fermentation using Streptomyces natalensis, is widely used throughout the world as a food preservative and has a long history of safe use in the food industry. It is very effective against all known food spoilage fungi. Although natamycin has been applied in e.g. the cheese industry for many years, up to now development of resistant fungal species has never been observed.

Consequently, it can be concluded that there is a severe need for more effective, more environmental friendly, lower-toxicity and less harmful antimicrobial compositions, e.g. antifungal compositions, for the treatment of fungal growth in and on plants and crops.

### DESCRIPTION OF THE INVENTION

The present invention solves the problem by providing a new synergistic antimicrobial, e.g. antifungal, composition comprising a polyene antifungal compound and at least one antifungal compound from the family of imidazole fungicides. As used herein, the term “synergistic” means that the combined effect of the antifungal compounds when used in combination is greater than their additive effects when used individually.

In general, synergistic activity of two active ingredients can be tested in for example the analysis of variance model using the treatment interaction stratum (see Slinker, 1998). Relative efficacy can be calculated by means of the following formula: ((value of evolution status of untreated control - value of evolution status of composition)/(value of evolution status of untreated control))*100. An interaction coefficient can then be calculated by means of the following formula: ((relative efficacy of combination compound A+compound B)/(relative efficacy of compound A+relative efficacy of compound B))*100. An interaction coefficient larger than 100 indicates synergy between the compounds.

Alternatively, synergy can be calculated as follows: the antifungal activity (in %) of the individual active ingredients can be determined by calculating the reduction in mould growth observed on products treated with the active ingredients in comparison to the mould growth on products treated with a control composition. The expected antifungal activity (E in %) of the combined antifungal composition comprising both active ingredients can be calculated according to the Colby equation (Colby, 1967): E=X+Y−[(X·Y)/100], wherein X and Y are the observed antifungal activities (in %) of the individual active ingredients X and Y, respectively. If the observed antifungal activity (0 in %) of the combination exceeds the expected antifungal activity (E in %) of the combination and the synergy factor O/E is thus >1.0, the combined application of the active ingredients leads to a synergistic antifungal effect.

In an embodiment of the invention, the at least one antifungal compound from the family of imidazole fungicides is selected from the group consisting of cyazofamid, fenamidone, fenapanil, glyodin, isovaledione, pefurazoate and triazoxide. In a preferred embodiment the at least one antifungal compound from the family of imidazole fungicides is selected from the group consisting of cyazofamid and fenamidone. In an embodiment the compositions may also contain two or more different antifungal compounds from the family of imidazole fungicides, so for instance the compositions may comprise cyazofamid and fenamidone. It is to be understood that derivatives of antifungal compounds from the family of imidazole fungicides including, but not limited to, salts or solvates of antifungal compounds from the family of imidazole fungicides or modified forms of antifungal compounds from the family of imidazole fungicides may also be applied in the compositions of the invention. Examples of commercial products containing imidazole fungicides such as triazoxide are the products with the brand name Gaucho Orge® (imidacloprid+tebuconazole+triazoxide) or Raxil S® (tebuconazole+triazoxide). Examples of commercial products containing imidazole fungicides such as fenamidone are the products with the brand name Censor® (fenamidone), Reason® (fenamidone), Consento® (fenamidone+propamocarb-HCl) or Verita® (fenamidone+fosetyl-Al). Examples of commercial products containing imidazole fungicides such as cyazofamid are the products with the brand name Ranman® 400SC (cyazofamid). Said commercial products can be incorporated in the present invention.

In an embodiment the polyene antifungal compound is selected from the group consisting of natamycin, nystatin, amphotericin B, trienin, etruscomycin, filipin, chainin, dermostatin, lymphosarcin, candicidin, aureofungin A, aureofungin B, hamycin A, hamycin B and lucensomycin. In a preferred embodiment the polyene antifungal compound is natamycin. In an embodiment the compositions may also contain two or more different polyene antifungal compounds. It is to be understood that derivatives of polyene antifungal compounds including, but not limited to, salts or solvates of polyene antifungal compounds or modified forms of polyene antifungal compounds may also be applied in the compositions of the invention. Examples of commercial products containing natamycin are the products with the brand name Delvocid®. Such products are produced by DSM Food Specialties (The Netherlands) and may be solids containing e.g. 50% (w/w) natamycin or liquids comprising between e.g. 2-50% (w/v) natamycin. Said commercial products can be incorporated in the compositions of the invention. The composition of the present invention generally comprises from about 0.005 g/l to about 100 g/l and preferably from about 0.01 g/l to about 50 g/l of a polyene antifungal compound. Preferably, the amount is from 0.01 g/l to 3 g/l.

The composition of the present invention generally comprises from about 0.0001 g/I to about 2000 g/l and preferably from about 0.0005 g/l to about 1500 g/l of an antifungal compound from the family of imidazole fungicides. More preferably, the amount is from 0.001 g/l to 1000 g/l.

In an embodiment the composition of the present invention further comprises at least one additional compound selected from the group consisting of a sticking agent, a carrier, a colouring agent, a protective colloid, an adhesive, a herbicide, a fertilizer, a thickening agent, a sequestering agent, a thixotropic agent, a surfactant, a further antimicrobial compound, a detergent, a preservative, a spreading agent, a filler, a spray oil, a flow additive, a mineral substance, a solvent, a dispersant, an emulsifier, a wetting agent, a stabiliser, an antifoaming agent, a buffering agent, an UV-absorber and an antioxidant. A further antimicrobial antifungal compound may be an antifungal compound (e.g. imazalil, thiabendazole or chlorthalonil) or a compound to combat insects, nematodes, mites and/or bacteria. Of course, the compositions according to the invention may also comprise two or more of any of the above additional compounds. Any of the above mentioned additional compounds may also be combined with the polyene antifungal compound and/or the at least one antifungal compound from the family of imidazole fungicides in case the antifungal compounds are applied separately. In an embodiment the additional compounds are additives acceptable for the specific use, e.g. food, feed, medicine, cosmetics or agriculture. Additional compounds suitable for use in food, feed, medicine, cosmetics or agriculture are known to the person skilled in the art.

In a specific embodiment the further antimicrobial compound is a natural crop protection compound belonging to the group of phosphites, e.g. KH₂PO₃ or K₂HPO₃ or a mixture of both phosphite salts. Phosphite containing compounds as used herein means compounds comprising a phosphite group, i.e. PO₃ (in the form of e.g. H₂PO₃⁻, HPO₃²⁻ or PO₃³⁻) or any compound which allows the release of a phosphite ion including compounds such as phosphorous acid and phosphonic acid as well as derivatives thereof such as esters and/or alkali metal or alkaline earth metal salts thereof. In case the compositions of the present invention comprise a polyene antifungal compound (e.g. natamycin) and at least one phosphite containing compound, they preferably comprise 0.1 g or less lignosulphonate, more preferably 0.1 g or less polyphenol, per gram polyene antifungal compound. Preferably, they comprise 0.01 g or less lignosulphonate, more preferably 0.01 g or less polyphenol, per gram polyene antifungal compound. In particular, they are free of lignosulphonate and preferably free of polyphenol. Suitable examples of phosphite containing compounds are phosphorous acid and its (alkali metal or alkaline earth metal) salts such as potassium phosphites e.g. KH₂PO₃ and K₂HPO₃, sodium phosphites and ammonium phosphites, and (C₁-C₄) alkyl esters of phosphorous acid and their salts such as aluminum ethyl phosphite (fosetyl-Al), calcium ethyl phosphite, magnesium isopropyl phosphite, magnesium isobutyl phosphite, magnesium sec-butyl phosphite and aluminum N-butyl phosphite. Of course, mixtures of phosphite containing compounds are also encompassed. A mixture of e.g. KH₂PO₃ and K₂HPO₃ can easily be obtained by e.g. adding KOH or K₂CO₃ to a final pH of 5.0-6.0 to a KH₂PO₃ solution. As indicated above, precursor-type compounds which in the crop or plant are metabolized into phosphite compounds can also be included in the compositions of the present invention. Examples are phosphonates such as the fosetyl-aluminium complex. In e.g. a crop or plant the ethyl phosphonate part of this molecule is metabolized into a phosphite. An example of such a compound in the commercial ethyl hydrogen phosphonate product called Aliette® (Bayer, Germany). The ratio of phosphite to natamycin (in weight) in the compositions is in general between 2:1 to 500:1 (w/w), preferably between 3:1 to 300:1 (w/w) and more preferably between 5:1 to 200:1 (w/w).

Compositions according to the invention may have a pH of from 1 to 10, preferably of from 2 to 9, more preferably of from 3 to 8 and most preferably of from 4 to 7. They may be solid, e.g. powder compositions, or may be liquid. The compositions of the present invention can be aqueous or non-aqueous ready-to-use compositions, but may also be aqueous or non-aqueous concentrated compositions/suspensions or stock compositions, suspensions and/or solutions which before use have to be diluted with a suitable diluent such as water or a buffer system. Alternatively, the compositions of the invention can also be used to prepare coating emulsions. The compositions of the present invention can also have the form of concentrated dry products such as e.g. powders, granulates and tablets. They can be used to prepare compositions for immersion or spraying of products such as agricultural products including plants, crops, vegetables and/or fruits. Of course, the above is also applicable when the polyene antifungal compound and the at least one antifungal compound from the family of imidazole fungicides are applied as separate compositions.

In a further aspect the invention relates to a kit comprising a polyene antifungal compound and at least one antifungal compound from the family of imidazole fungicides. The polyene antifungal compound and the at least one antifungal compound from the family of imidazole fungicides may be present in two separate packages, e.g. containers. The components of the kit may be either in dry form or liquid form in the package. If necessary, the kit may comprise instructions for dissolving the compounds. In addition, the kit may contain instructions for applying the compounds.

In a further aspect the invention pertains to a method for protecting a product against fungi by treating the agricultural product with a polyene antifungal compound and at least one antifungal compound from the family of imidazole fungicides. In addition, the product can be treated with other antifungal and/or antimicrobial compounds either prior to, concomitant with or after treatment of the products with the polyene antifungal compound and the at least one antifungal compound from the family of imidazole fungicides. The product may be treated by sequential application of the polyene antifungal compound and the at least one antifungal compound from the family of imidazole fungicides or vice versa. Alternatively, the product may be treated by simultaneous application of the polyene antifungal compound and the at least one antifungal compound from the family of imidazole fungicides. In case of simultaneous application, the compounds can be present in different compositions that are applied simultaneously or the compounds may be present in a single composition. In yet another embodiment the product may be treated by separate or alternate modes of applying the antifungal compounds. In an embodiment the invention is directed to a process for the treatment of products by applying the polyene antifungal compound and the at least one antifungal compound from the family of imidazole fungicides to the products. By applying the compounds fungal growth on or in the products can be prevented. In other words, the compounds protect the products from fungal growth and/or from fungal infection and/or from fungal spoilage. The compounds can also be used to treat products that have been infected with a fungus. By applying the compounds the disease development due to fungi on or in these products can be slowed down, stopped or the products may even be cured from the disease. In an embodiment of the invention the products are treated with a composition or kit according to the invention. In an embodiment the product is a food, feed, pharmaceutical, cosmetic or agricultural product. In a preferred embodiment the product is an agricultural product.

The polyene antifungal compound and the at least one antifungal compound from the family of imidazole fungicides, the compositions according to the invention and the kits according to the invention can be applied to the products by spraying. Other methods suitable for applying these compounds, compositions and kits in liquid form to the products are also a part of the present invention. These include, but are not limited to, dipping, watering, drenching, introduction into a dump tank, vaporizing, atomizing, fogging, fumigating, painting, brushing, dusting, foaming, spreading-on, packaging and coating (e.g. by means of wax or electrostatically). In addition, the antifungal compounds may also be injected into the soil. Spraying applications using automatic systems are known to reduce the labour costs and are cost-effective. Methods and equipment well-known to a person skilled in the art can be used for that purpose. The compositions according to the invention can be regularly sprayed, when the risk of infection is high. When the risk of infection is lower spray intervals may be longer. Depending on the type of application, the amount of polyene antifungal compound applied may vary from 5 ppm to 10,000 ppm, preferably from 10 ppm to 5,000 ppm and most preferably from 20 to 1,000 ppm. Depending on the type of application, the amount of the at least one antifungal compound from the family of imidazole fungicides applied may vary from 10 ppm to 5,000 ppm, preferably from 20 ppm to 3,000 ppm and most preferably from 50 to 1,000 ppm.

In a specific embodiment the agricultural product can be treated post-harvest. By using a polyene antifungal compound and the at least one antifungal compound from the family of imidazole fungicides the control of post-harvest and/or storage diseases is achieved for a long period of time to allow transport of the harvested agricultural product over long distances and under various storage conditions with different controlled atmosphere systems in respect of temperature and humidity. Post-harvest storage disorders are e.g. lenticel spots, scorch, senescent breakdown, bitter pit, scald, water core, browning, vascular breakdown, CO₂ injury, CO₂ or O₂ deficiency, and softening. Fungal diseases may be caused for example by the following fungi: Mycosphaerella spp., Mycosphaerella musae, Mycosphaerella fragariae, Mycosphaerella citri; Mucor spp., e.g. Mucor piriformis; Monilinia spp., e.g. Monilinia fructigena, Monilinia laxa; Phomopsis spp., Phomopsis natalensis; Colletotrichum spp., e.g. Colletotrichum musae, Colletotrichum gloeosporioides, Colletotrichum coccodes; Verticillium spp., e.g. Verticillium theobromae; Nigrospora spp.; Botrytis spp., e.g. Botrytis cinerea; Diplodia spp., e.g. Diplodia citri; Pezicula spp.; Alternaria spp., e.g. Alternaria citri, Alternaria alternata; Septoria spp., e.g. Septoria depressa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Fusarium spp., e.g. Fusarium semitectum, Fusarium moniliforme, Fusarium solani, Fusarium oxysporum; Cladosporium spp., e.g. Cladosporium fulvum, Cladosporium cladosporioides, Cladosporium cucumerinum, Cladosporium musae; Penicillium spp., e.g. Penicillium funiculosum, Penicillium expansum, Penicillium digitatum, Penicillium italicum; Phytophthora spp., e.g. Phytophthora citrophthora, Phytophthora fragariae, Phytophthora cactorum, Phytophthora parasitica; Phacydiopycnis spp., e.g. Phacydiopycnis malirum; Gloeosporium spp., e.g. Gloeosporium album, Gloeosporium perennans, Gloeosporium fructigenum, Gloeosporium singulata; Geotrichum spp., e.g. Geotrichum candidum; Phlyctaena spp., e.g. Phlyctaena vagabunda; Cylindrocarpon spp., e.g. Cylindrocarpon mali; Stemphyllium spp., e.g. Stemphyllium vesicarium; Thielaviopsis spp., e.g. Thielaviopsis paradoxy; Aspergillus spp., e.g. Aspergillus niger, Aspergillus carbonarius; Nectria spp., e.g. Nectria gaffigena; Cercospora spp., e.g. Cercospora angreci, Cercospora apii, Cercospora atrofiliformis, Cercospora musae, Cercospora zeae-maydis. maydis.

Another aspect of the present invention relates to the use of a polyene antifungal compound and at least one antifungal compound from the family of imidazole fungicides to protect a product against fungi. As indicated above, the compounds may be used, e.g. applied, sequentially or simultaneously. In an embodiment the invention relates to a use, wherein a composition or kit according to the invention is applied to the product. In an embodiment the product is a food, feed, pharmaceutical, cosmetic or agricultural product. In a preferred embodiment the product is an agricultural product.

In a specific embodiment the polyene antifungal compound and at least one antifungal compound from the family of imidazole fungicides can be used in medicine, e.g. to treat and/or prevent fungal diseases. The polyene antifungal compound and at least one antifungal compound from the family of imidazole fungicides can for instance be used in the form of a pharmaceutical composition. The composition may further comprise pharmaceutically acceptable excipients. The antifungal compounds may be administered orally or parenterally. The type of composition is dependent on the route of administration.

A further aspect of the invention is directed to a product treated with a polyene antifungal compound and at least one antifungal compound from the family of imidazole fungicides. In an embodiment the product is treated with a composition or kit according to the invention. The invention is therefore directed to a product comprising a polyene antifungal compound and at least one antifungal compound from the family of imidazole fungicides. The treated products may comprise a polyene antifungal compound and at least one antifungal compound from the family of imidazole fungicides on their surface and/or inside the product. Alternatively, the treated products may comprise a coating comprising these compounds. In an embodiment the treated products comprise from 0.000001 to 200 mg/dm², preferably 0.00001 to 100 mg/dm², more preferably from 0.00005 to 10 mg/dm² of the polyene antifungal compound on their surface. In a further embodiment they comprise from 0.000001 to 200 mg/dm², preferably 0.00001 to 100 mg/dm², more preferably from 0.00005 to 10 mg/dm² of the at least one antifungal compound from the family of imidazole fungicides on their surface. In an embodiment the product is a food, feed, pharmaceutical, cosmetic or agricultural product. In a preferred embodiment the product is an agricultural product.

The term “food products” as used herein is to be understood in a very broad sense and includes, but is not limited to, cheese, cream cheese, shredded cheese, cottage cheese processed cheese, sour cream, dried fermented meat product including salamis and other sausages, wine, beer, yoghurt, juice and other beverages, salad dressing, cottage cheese dressing, dips, bakery products and bakery fillings, surface glazes and icing, spreads, pizza toppings, confectionery and confectionery fillings, olives, olive brine, olive oil, juices, tomato purees and paste, condiments, and fruit pulp and the like food products.

The term “feed products” as used herein is also to be understood in a very broad sense and includes, but is not limited to, pet food, broiler feed, etc.

The term “pharmaceutical product” as used herein is also to be understood in a very broad sense and includes products comprising an active molecule such as a drug, agent, or pharmaceutical compound and optionally a pharmaceutically acceptable excipient, i.e. any inert substance that is combined with the active molecule for preparing an agreeable or convenient dosage form.

The term “cosmetic product” as used herein is also to be understood in a very broad sense and includes products that are used for protecting or treating horny tissues such as skin and lips, hair and nails from drying by preventing transpiration of moisture thereof and further conditioning the tissues as well as giving good appearance to these tissues. Products contemplated by the term “cosmetic product” include, but are not limited to, moisturizers, personal cleansing products, occlusive drug delivery patches, nail polish, powders, wipes, hair conditioners, skin treatment emulsions, shaving creams and the like.

The term “agricultural products” as used herein is also to be understood in a very broad sense and includes, but is not limited to, cereals, e.g. wheat, barley, rye, oats, rice, sorghum and the like; beets, e.g. sugar beet and fodder beet; pome and stone fruit and berries, e.g. apples, pears, plums, apricots, peaches, almonds, cherries, strawberries, raspberries and blackberries; leguminous plants, e.g. beans, lentils, peas, soy beans; oleaginous plants, e.g. rape, mustard, poppy, olive, sunflower, coconut, castor-oil plant, cocoa, ground-nuts; cucurbitaceae, e.g. pumpkins, gherkins, melons, cucumbers, squashes, aubergines; fibrous plants, e.g. cotton, flax, hemp, jute; citrus fruit, e.g. oranges, lemons, grapefruits, mandarins, limes; tropical fruit, e.g. papayas, passion fruit, mangos, carambolas, pineapples, bananas, kiwis; vegetables, e.g. spinach, lettuce, asparagus, brassicaceae such as cabbages and turnips, carrots, onions, tomatoes, potatoes, seed-potatoes, hot and sweet peppers; laurel-like plants, e.g. avocado, cinnamon, camphor tree; or products such as maize, tobacco, nuts, coffee, sugarcane, tea, grapevines, hops, rubber plants, as well as ornamental plants, e.g. cut flowers, roses, tulips, lilies, narcissus, crocuses, hyacinths, dahlias, gerbera, carnations, fuchsias, chrysanthemums, and flower bulbs, shrubs, deciduous trees and evergreen trees such as conifers, plants and trees in greenhouses. It includes, but is not limited to, plants and their parts, fruits, seeds, cuttings, cultivars, grafts, bulbs, tubers, root-tubers, rootstocks, cut flowers and vegetables.

A method for preparing a composition as described herein is another aspect of the present invention. The method comprises adding a polyene antifungal compound to at least one antifungal compound from the family of imidazole fungicides. The compounds may for instance be added separately to an aqueous composition and mixed, followed, if necessary, by adjustment of the pH, viscosity, etc. If added separately, some or all of the separate compounds may be in powder form, but alternatively some or all may also be in liquid form. The compounds may for instance also be added to one another in powder form and mixed to obtain a powdered composition. The powdered composition may then be added to an aqueous composition.

### EXAMPLES

### Example 1

### Pre-Harvest Application

Leaves of banana plants are inoculated with fungi. As a control non-inoculated leaves are also included. Next, a defined part of the leaves are treated with composition 1 (natamycin), composition 2 (cyazofamid), composition 3 (fenamidone), composition 4 (fenapanil), composition 5 (glyodin), composition 6 (isovaledione), composition 7 (pefurazoate), composition 8 (triazoxide), composition 9 (natamycin+cyazofamid), composition 10 (natamycin+fenamidone), composition 11 (natamycin+fenapanil), composition 12 (natamycin+glyodin), composition 13 (natamycin+isovaledione), composition 14 (natamycin+pefurazoate) or composition 15 (natamycin+triazoxide). Each composition is applied by spraying. Untreated leaves are also included (untreated control).

The obtained results show that the compositions of the present invention protect banana plants from fungal growth and further demonstrate that the compositions of the present invention show a synergistically enhanced activity compared to the activity of the active compounds when applied individually.

### Example 2

### Post-Harvest Application

Bananas are injured according to the method described by de Lapeyre de Bellaire and Dubois (1987). Bananas are wounded using a cork borer followed by contamination with fungal spores. After incubation for several hours at room temperature, the bananas are dipped in one of the following compositions: a) no treatment (control 1), b) dipped in water (control 2), c) dipped in natamycin, d) dipped in cyazofamid, e) dipped in fenamidone, f) dipped in fenapanil, g) dipped in glyodin, h) dipped in isovaledione, i) dipped in pefurazoate, j) dipped in triazoxide, k) dipped in natamycin+cyazofamid, l) dipped in natamycin+fenamidone, m) dipped in natamycin+fenapanil, n) dipped in natamycin+glyodin, o) dipped in natamycin+isovaledione, p) dipped in natamycin+pefurazoate or q) dipped in natamycin+triazoxide. After this treatment the bananas are incubated in closed boxes at 21° C. at elevated humidity. Each day the bananas are judged visually on fungal development.

The results show that the composition comprising natamycin and at least one antifungal compound from the family of imidazole fungicides protects bananas better against fungi than natamycin or at least one antifungal compound from the family of imidazole fungicides alone. Surprisingly, the combined application of natamycin and at least one antifungal compound from the family of imidazole fungicides leads to a strong synergistic reduction in infection.

### Example 3

### Treatment of Bananas

Four organic, unripe (green) bananas were used per treatment. The peel of each banana was wounded thrice using a cork borer according to the method described by de Lapeyre de Bellaire and Dubois (1987). Subsequently, each wound was inoculated with 15 μl of a Fusarium proliferatum suspension containing 1×10⁵ of spores/ml. After incubation for 4 hours at 20° C., each banana wound was treated with 100 μl of a freshly prepared aqueous antifungal composition comprising either 500 ppm natamycin (DSM Food Specialties, Delft, The Netherlands), 2000 ppm cyazofamid or both. In addition, the antifungal compositions comprised 1.00% (w/w) methylhydroxyethylcellulose (MHEC), 0.40% (w/w) xanthan gum, 0.20% (w/w) anti-foaming agent, 0.30% (w/w) citric acid, 0.39% (w/w) lactic acid and 0.11% (w/w) potassium sorbate. The pH of the composition was 4. A composition without natamycin or cyazofamid was used as control.

The treated, unripe bananas were incubated in a closed box in the dark at 20° C. and a relative air humidity of 95%, which was obtained in the presence of a saturated Na₂HPO₄ aqueous solution. A ripe (yellow) banana was included in the closed box to elevate the ethylene gas level and thus induce ripening of the treated, unripe bananas.

During incubation, the antifungal activity (in %) of the individual active ingredients was determined by calculating the reduction in mould growth observed on the banana wounds treated with the antifungal composition in comparison to the mould growth on the banana wounds treated with the control composition. The expected antifungal activity (E in %) of the combined antifungal composition comprising both active ingredients was calculated according to the Colby equation (Colby, 1967):

E=X+Y−[(X·Y)/100]

wherein X and Y are the observed antifungal activities (in %) of the individual active ingredients X and Y, respectively. If the observed antifungal activity (O in %) of the combination exceeds the expected antifungal activity (E in %) of the combination and the synergy factor O/E is thus >1.0, the combined application of the active ingredients leads to a synergistic antifungal effect.

The results in Table 1 clearly demonstrate that the antifungal composition comprising both 500 ppm natamycin and 2000 ppm cyazofamid protected bananas better against mould growth than natamycin or cyazofamid individually.

After 21, 23 and 24 days of incubation, the observed antifungal activity of the composition comprising both natamycin and fluoxastrobin was 6 to 14% higher than the expected antifungal activity and a synergy factor of >1.0 was obtained (see Table 1).

Hence, the combination of 500 ppm natamycin and 2000 ppm cyazofamid has synergistic antifungal activity on bananas.

### Example 4

### Treatment of Bananas

The experiment was conducted as described in Example 3, except for the fact that each inoculated banana wound was treated with 100 μl of a freshly prepared aqueous antifungal composition comprising either 250 ppm natamycin (DSM Food Specialties, Delft, The Netherlands), 500 ppm cyazofamid or both. The antifungal activity (in %) of the individual and combined active ingredients on the banana wounds was determined according to the method described in Example 3.

The results in Table 2 reveal that the antifungal composition comprising 250 ppm natamycin as well as 500 ppm cyazofamid was superior to the compositions comprising either natamycin or cyazofamid in reducing mould growth on bananas.

After 27 days of incubation, the observed antifungal activity of the composition comprising both natamycin and cyazofamid was almost 40% higher than the expected antifungal activity. Consequently, the corresponding synergy factor exceeded 1.0 by far (see Table 2).

Thus, the combined application of 250 ppm natamycin and 500 ppm cyazofamid results in a surprisingly strong synergistic reduction in mould growth on bananas.

### Example 5

### Treatment of Bananas

The experiment was conducted as described in Example 3, except for the fact that each inoculated banana wound was treated with 100 μl of a freshly prepared aqueous antifungal composition comprising either 50 ppm natamycin (DSM Food Specialties, Delft, The Netherlands), 250 ppm cyazofamid or both. The antifungal activity (in %) of the individual and combined active ingredients on the banana wounds was determined according to the method described in Example 3.

The results in Table 3 show that the combined antifungal composition comprising 50 ppm natamycin and 250 ppm cyazofamid protected bananas more effectively against mould growth on bananas than the compositions comprising natamycin or cyazofamid individually.

After 27 days incubation, the actually observed antifungal activity of the composition comprising both natamycin and cyazofamid was 20% higher than the expected antifungal activity, which resulted in a synergy factor >1.0 (see Table 3).

In conclusion, the results of this example prove that the combined application of 50 ppm natamycin and 250 ppm cyazofamid synergistically reduces mould growth on bananas.

### Example 6

### Treatment of Strawberries

Twelve fresh, organic strawberries were used per treatment. Each strawberry was wounded with a 0.5 mm long cut and each wound was inoculated with 10 μl of a Botrytis cinerea suspension containing 1×10⁵ of spores/ml. After a 2-hour incubation period at 20° C., each strawberry was dipped individually for 1 minute in a freshly prepared aqueous antifungal composition comprising either 500 ppm natamycin (DSM Food Specialties, Delft, The Netherlands), 1000 ppm fenamidone or both. The antifungal composition also comprised 1.00% (w/w) methylhydroxyethylcellulose (MHEC), 0.40% (w/w) xanthan gum, 0.20% (w/w) anti-foaming agent, 0.30% (w/w) citric acid, 0.39% (w/w) lactic acid and 0.11% (w/w) potassium sorbate. The pH of the composition was 4. A composition without natamycin or fenamidone was used as control.

The treated strawberries were incubated in a closed box in the dark at 20° C. after 3, 4, 5, 7, 8 and 9 days of incubation. The degree of mould growth on the strawberries was assessed in a twofold manner: (i) the number of moulded strawberries per total of 12 strawberries was counted; and (ii) the antifungal activity (in %) of the individual active ingredients was determined by calculating the reduction in mould growth observed on the strawberries treated with the antifungal composition in comparison to the mould growth on the strawberries treated with the control composition. The expected antifungal activity (E in %) of the combined antifungal composition comprising both active ingredients was calculated according to the Colby equation (Colby, 1967):

E=X+Y−[(X·Y)/100]

wherein X and Y are the observed antifungal activities (in %) of the individual active ingredients X and Y, respectively. If the observed antifungal activity (O in %) of the combination exceeds the expected antifungal activity (E in %) of the combination and the synergy factor O/E is thus >1.0, the combined application of the active ingredients leads to a synergistic antifungal effect.

The results in Table 4 (number of moulded strawberries per total of 12 strawberries) and Table 5 (antifungal activity) clearly demonstrate that the antifungal composition comprising 500 ppm natamycin and 1000 ppm fenamidone had a much stronger antifungal activity on strawberries than natamycin or fenamidone alone.

After 3 days of incubation, all 12 strawberries treated with either the control composition or fenamidone alone were moulded, as were 3 of the strawberries treated with natamycin alone. However, mould growth was observed only for 1 of the 12 strawberries treated with the composition comprising natamycin and fenamidone (see Table 4). Furthermore, the observed antifungal activity of the composition comprising both natamycin and fenamidone exceeded the expected antifungal activity with 14% on day 3 and 12% on day 4. Consequently, synergy factors >1.0 were obtained (see Table 5).

After 5 days of incubation, all 12 strawberries treated with either the control composition or fenamidone alone were moulded, as were 11 of the 12 strawberries treated with natamycin alone. However, mould growth was observed for only 8 of the 12 strawberries treated with the composition comprising natamycin and fenamidone (see Table 4). In addition, the observed antifungal activity of the combined composition comprising natamycin and fenamidone was >30% higher than the expected antifungal activity, which resulted in a synergy factor >1.0 (see Table 5).

After 7, 8 and 9 days of incubation, the observed antifungal activity of the composition comprising both natamycin and fenamidone was 18 to 26% higher than the expected antifungal activity. The corresponding synergy factor exceeded 1.0 on each of these three consecutive days and even increased from 3.0 on day 7 to >18 on days 8 and 9 (see Table 5).

In conclusion, the combined application of 500 ppm natamycin and 1000 ppm fenamidone is extremely effective in synergistically reducing mould growth on strawberries.

### Example 7

### Treatment of Strawberries

The experiment was conducted as described in Example 6, except for the fact that each wounded and inoculated strawberry was dipped individually for 1 minute in a freshly prepared aqueous antifungal composition comprising either 50 ppm natamycin (DSM Food Specialties, Delft, The Netherlands), 250 ppm fenamidone or both. The treated strawberries were assessed on mould growth after 3, 4, 5, 7, 8 and 9 days of incubation according to the two methods described in Example 6.

The results in Table 6 (number of moulded strawberries per total of 12 strawberries) and Table 7 (antifungal activity) reveal that the antifungal composition comprising 250 ppm natamycin as well as 250 ppm fenamidone was more successful in limiting mould growth on strawberries than the compositions comprising either natamycin or fenamidone individually.

After 3, 4, and 5 days of incubation, all 12 strawberries treated with either the control composition or fenamidone alone were moulded, as were 3, 5 and 10 of the 12 strawberries treated with natamycin alone, respectively. However, when the active ingredient combination of natamycin and fenamidone was applied on the strawberries, only 1, 3 and 6 of the 12 strawberries showed mould growth after 3, 4 and 5 days of incubation, respectively (see Table 6). Moreover, the observed antifungal activity of the composition comprising natamycin and fenamidone exceeded the expected antifungal activity with 22% on day 3, 28% on day 4 and even 44% on day 5. Consequently, the obtained synergy factor was >1.0 on each of these three days and ranged from 1.6 to 3.8 (see Table 7).

After 7, 8 and 9 days of incubation, the observed antifungal activity of the composition comprising both natamycin and fenamidone was 13 to 20% higher than the expected antifungal activity. The corresponding synergy factor exceeded 1.0 on each of these three consecutive days and even increased to >13 on day 9 (see Table 7).

Thus, a surprisingly strong synergistic activity against fungi exists between 50 ppm natamycin and 250 ppm fenamidone when applied in combination on strawberries.

### Example 8

### In Vitro Antifungal Activity

To demonstrate synergistic antifungal activity of the combination of natamycin with cyazofamid or fenamidone against Botrytis cinerea, an in vitro assay was conducted using 96-well microtiter plates. The following compositions were tested:
Control (no active ingredient),
0.63 natamycin (DSM Food Specialties, Delft, The Netherlands),
25 ppm cyazofamid,
50 ppm fenamidone,
0.63 ppm natamycin+25 ppm cyazofamid,
0.63 ppm natamycin+50 ppm fenamidone.
   After filling each well of a microtiter plate with 92 μl of PCB medium, the active ingredient(s) were added from separate stock solutions prepared in PCB medium or methanol, which resulted in an intermediate volume of 100 μl per well. Subsequently, 100 μl of a Botrytis cinerea suspension prepared in PCB medium was used to inoculated each well with 2.5×10³spores/ml. Each well thus contained a final volume of 200 μl and <1% of methanol, which did not affect growth of Botrytis cinerea (data not shown).

After incubation of the microtiter plates for 7 at 25° C., the in vitro antifungal activity (%) of the individual active ingredients was assessed by calculating the reduction in mould growth observed in the presence of the active ingredient in comparison to the mould growth observed in the absence of the active ingredient. The expected antifungal activity (E in %) of the active ingredient combination was calculated according to the Colby equation (Colby, 1967):

E=X+Y−[(X·Y)/100]

wherein X and Y are the observed antifungal activities (in %) of the individual active ingredients X and Y, respectively. If the observed antifungal activity (O in %) of the combination exceeds the expected antifungal activity (E in %) of the combination and the resulting synergy factor O/E is thus >1.0, the combined application of the active ingredients leads to a synergistic antifungal effect.

The results (see Table 8) demonstrate that both the natamycin+cyazofamid combination and the natamycin+fenamidone combination had much stronger antifungal activities against Botrytis cinerea than natamycin, cyazofamid or fenamidone alone. The observed antifungal activities of the combinations natamycin+cyazofamid and natamycin+fenamidone were 100% higher than the expected antifungal activities and synergy factors far above 1.0 were therefore obtained.

The results of this example clearly show that the combined application of natamycin and cyazofamid as well as the combined application of natamycin and fenamidone synergistically inhibit growth of Botrytis cinerea.

### Example 9

### In Vitro Antifungal Activity

The experiment was conducted as described in Example 8, except for the fact that the following compositions were tested:
Control (no active ingredient),
2.5 ppm natamycin (DSM Food Specialties, Delft, The Netherlands),
50 or 75 ppm cyazofamid,
2.5 ppm natamycin +50 ppm cyazofamid,
2.5 ppm natamycin +75 ppm cyazofamid.
   Furthermore, Fusarium proliferatum was used for inoculation. After 5 days of incubation at 25° C., the antifungal activity (in %) of the individual and combined active ingredients was determined according to the method described in Example 8.

The results in Table 9 prove that the active ingredient combination of natamycin+cyazofamid inhibits growth of Fusarium proliferatum more effectively than natamycin or cyazofamid individually. The observed antifungal activities of the composition comprising natamycin as well as cyazofamid exceeded the expected antifungal activities with 50 to 100%, which resulted in synergy factors far above 1.0.

Hence, the combined application of natamycin and cyazofamid has strong synergistic antifungal activity against Fusarium proliferatum.

TABLE 1
Antifungal activity (%) of compositions comprising either 500 ppm
natamycin, 2000 ppm cyazofamid or both on bananas after incubation
at 20° C.

| | | Observed | | |
|---|---|---|---|---|
| | Incubation | antifungal | Expected | Synergy |
| Antifungal | time | activity O | antifungal | factor |
| composition | (days) | (%) | activity E (%) | O/E |
| Control | 21 | 0 | — | — |
| Natamycin 500 ppm | | 94 | — | — |
| Cyazofamid 2000 ppm | | 0 | — | — |
| Natamycin 500 ppm + | | 100 | 94 | 1.1 |
| cyazofamid 2000 ppm | | | | |
| Control | 23 | 0 | — | — |
| Natamycin 500 ppm | | 86 | — | — |
| Cyazofamid 2000 ppm | | 0 | — | — |
| Natamycin 500 ppm + | | 100 | 86 | 1.2 |
| cyazofamid 2000 ppm | | | | |
| Control | 24 | 0 | — | — |
| Natamycin 500 ppm | | 84 | — | — |
| Cyazofamid 2000 ppm | | 0 | — | — |
| Natamycin 500 ppm + | | 97 | 84 | 1.2 |
| cyazofamid 2000 ppm | | | | |

TABLE 2
Antifungal activity (%) of compositions comprising either 250 ppm
natamycin, 500 ppm cyazofamid or both on bananas after incubation
at 20° C.

| | | Observed | | |
|---|---|---|---|---|
| | Incubation | antifungal | Expected | Synergy |
| Antifungal | time | activity O | antifungal | factor |
| composition | (days) | (%) | activity E (%) | O/E |
| Control | 27 | 0 | — | — |
| Natamycin 250 ppm | | 4 | — | — |
| Cyazofamid 500 ppm | | 1 | — | — |
| Natamycin 250 ppm + | | 42 | 5 | 8.4 |
| cyazofamid 500 ppm | | | | |

TABLE 3
Antifungal activity (%) of compositions comprising either 50 ppm
natamycin, 250 ppm cyazofamid or both on bananas after incubation
at 20° C.

| | | Observed | | |
|---|---|---|---|---|
| | Incubation | antifungal | Expected | Synergy |
| Antifungal | time | activity O | antifungal | factor |
| composition | (days) | (%) | activity E (%) | O/E |
| Control | 27 | 0 | — | — |
| Natamycin 50 ppm | | 11 | — | — |
| Cyazofamid 250 ppm | | 0 | — | — |
| Natamycin 50 ppm + | | 31 | 11 | 2.8 |
| cyazofamid 250 ppm | | | | |

TABLE 4
Number of moulded strawberries incubated at 20° C. after treatment with
compositions comprising either 500 ppm natamycin, 1000 ppm
fenamidone or both.

Number of moulded strawberries/
total number of 12 strawberries
during incubation time (in days)

| Antifungal composition | Day 3 | Day 5 |
|---|---|---|
| Control | 12/12 | 12/12 |
| Natamycin 500 ppm | 3/12 | 11/12 |
| Fenamidone 1000 ppm | 12/12 | 12/12 |
| Natamycin 500 ppm + | 1/12 | 8/12 |
| fenamidone 1000 ppm | | |

TABLE 5
Antifungal activity (%) of compositions comprising either 500 ppm
natamycin, 1000 ppm fenamidone or both on strawberries after incubation
at 20° C.

| | | | Expected | |
|---|---|---|---|---|
| | Incubation | Observed | antifungal | Synergy |
| Antifungal | time | antifungal | activity E | factor |
| composition | (days) | activity O (%) | (%) | O/E |
| Control | 3 | 0 | — | — |
| Natamycin 500 ppm | | 75 | — | — |
| Fenamidone 1000 ppm | | 9 | — | — |
| Natamycin 500 ppm + | | 91 | 77 | 1.2 |
| fenamidone 1000 ppm | | | | |
| Control | 4 | 0 | — | — |
| Natamycin 500 ppm | | 69 | — | — |
| Fenamidone 1000 ppm | | 0 | — | — |
| Natamycin 500 ppm + | | 81 | 69 | 1.2 |
| fenamidone 1000 ppm | | | | |
| Control | 5 | 0 | — | — |
| Natamycin 500 ppm | | 31 | — | — |
| Fenamidone 1000 ppm | | 0 | — | — |
| Natamycin 500 ppm + | | 63 | 31 | 2.0 |
| fenamidone 1000 ppm | | | | |
| Control | 7 | 0 | — | — |
| Natamycin 500 ppm | | 13 | — | — |
| Fenamidone 1000 ppm | | 0 | — | — |
| Natamycin 500 ppm + | | 39 | 13 | 3.0 |
| fenamidone 1000 ppm | | | | |
| Control | 8 | 0 | — | — |
| Natamycin 500 ppm | | 0 | — | — |
| Fenamidone 1000 ppm | | 0 | — | — |
| Natamycin 500 ppm + | | 24 | 0 | >24 |
| fenamidone 1000 ppm | | | | |
| Control | 9 | 0 | — | — |
| Natamycin 500 ppm | | 0 | — | — |
| Fenamidone 1000 ppm | | 0 | — | — |
| Natamycin 500 ppm + | | 18 | 0 | >18 |
| fenamidone 1000 ppm | | | | |

TABLE 6
Number of moulded strawberries incubated at 20° C. after treatment with
compositions comprising either 50 ppm natamycin, 250 ppm
fenamidone or both.

| | Number of moulded strawberries/ | | |
|---|---|---|---|
| | total number of 12 strawberries | | |
| | during incubation time (in days) | | |
| Antifungal composition | Day 3 | Day 4 | Day 5 |
| Control | 12/12 | 12/12 | 12/12 |
| Natamycin 50 ppm | 3/12 | 5/12 | 10/12 |
| Fenamidone 250 ppm | 12/12 | 12/12 | 12/12 |
| Natamycin 50 ppm + | 1/12 | 3/12 | 6/12 |
| fenamidone 250 ppm | | | |

TABLE 7
Antifungal activity (%) of compositions comprising either 50 ppm
natamycin, 250 ppm fenamidone or both on strawberries after incubation
at 20° C.

| | | | Expected | |
|---|---|---|---|---|
| | Incubation | Observed | antifungal | Synergy |
| Antifungal | time | antifungal | activity E | factor |
| composition | (days) | activity O (%) | (%) | O/E |
| Control | 3 | 0 | — | — |
| Natamycin 50 ppm | | 64 | — | — |
| Fenamidone 250 ppm | | 0 | — | — |
| Natamycin 50 ppm + | | 86 | 64 | 1.3 |
| fenamidone 250 ppm | | | | |
| Control | 4 | 0 | — | — |
| Natamycin 50 ppm | | 50 | — | — |
| Fenamidone 250 ppm | | 0 | — | — |
| Natamycin 50 ppm + | | 78 | 50 | 1.6 |
| fenamidone 250 ppm | | | | |
| Control | 5 | 0 | — | — |
| Natamycin 50 ppm | | 17 | — | — |
| Fenamidone 250 ppm | | 0 | — | — |
| Natamycin 50 ppm + | | 61 | 17 | 3.6 |
| fenamidone 250 ppm | | | | |
| Control | 7 | 0 | — | — |
| Natamycin 50 ppm | | 17 | — | — |
| Fenamidone 250 ppm | | 0 | — | — |
| Natamycin 50 ppm + | | 37 | 17 | 2.2 |
| fenamidone 250 ppm | | | | |
| Control | 8 | 0 | — | — |
| Natamycin 50 ppm | | 10 | — | — |
| Fenamidone 250 ppm | | 0 | — | — |
| Natamycin 50 ppm + | | 26 | 10 | 2.6 |
| fenamidone 250 ppm | | | | |
| Control | 9 | 0 | — | — |
| Natamycin 50 ppm | | 0 | — | — |
| Fenamidone 250 ppm | | 0 | — | — |
| Natamycin 50 ppm + | | 13 | 0 | >13 |
| fenamidone 250 ppm | | | | |

TABLE 8
In vitro antifungal activity (%) of natamycin in combination with
cyazofamid or fenamidone against Botrytis cinerea after incubation
at 25° C.

| | | | Expected | |
|---|---|---|---|---|
| | Incubation | Observed | antifungal | Synergy |
| Antifungal | time | antifungal | activity E | factor |
| composition | (days) | activity O (%) | (%) | O/E |
| Control | 7 | 0 | — | — |
| Natamycin 0.63 ppm | | 0 | — | — |
| Cyazofamid 25 ppm | | 0 | — | — |
| Fenamidone 50 ppm | | 0 | — | — |
| Natamycin 0.63 ppm + | | 100 | 0 | >100 |
| Cyazofamid 25 ppm | | | | |
| Natamycin 0.63 ppm + | | 100 | 0 | >100 |
| Fenamidone 50 ppm | | | | |

TABLE 9
In vitro antifungal activity (%) of natamycin in combination with
cyazofamid or fenamidone against Fusarium proliferatum after incubation
at 25° C.

| | | | Expected | |
|---|---|---|---|---|
| | Incubation | Observed | antifungal | Synergy |
| Antifungal | time | antifungal | activity E | factor |
| composition | (days) | activity O (%) | (%) | O/E |
| Control | 5 | 0 | — | — |
| Natamycin 2.5 ppm | | 0 | — | — |
| Cyazofamid 50 ppm | | 0 | — | — |
| Cyazofamid 75 ppm | | 0 | — | — |
| Natamycin 2.5 ppm + | | 50 | 0 | >50 |
| Cyazofamid 50 ppm | | | | |
| Natamycin 2.5 ppm + | | 100 | 0 | >100 |
| Cyazofamid 75 ppm | | | | |

### REFERENCES

Colby S R (1967), Calculating synergistic and antagonistic responses of herbicide combination. Weeds 15: 20-22.
Kardin M K and Percich J A (1983), Resistance to Bipolaris oryzae to fenapanil. Plant Disease 67:871-874.
Lapeyre de Bellaire de L and Dubois C (1987), Distribution of Thiabendazole-Resistant Colletotrichum musae Isolates from Guadeloupe Banana Plantations. Plant disease 81:1378-1383.
Mercer R T, Lacroix G, Gouot M and Latorse M P (1998), RPA 407213 a novel fungicide for the control of downey mildew, late blight and other diseases on a range of crops. Proceedings of the British Crop Protection Conference—Pests and Diseases 2, 319-326.
Slinker B K (1998), The Statistics of Synergism. Journal of Mol. and Cell. Cardiology 30:723-731.

1-15. (canceled)

16. A composition comprising natamycin and at least one antifungal compound from the family of imidazole fungicides selected from the group consisting of fenamidone, cyazofamid, fenapanil, glyodin, isovaledione, pefurazoate and triazoxide.

17. A composition according to claim 16, comprising natamycin and fenamidone and/or cyazofamid.

18. A composition according to claim 16, wherein the composition further comprises at least one additional compound selected from the group consisting of a sticking agent, a carrier, a colouring agent, a protective colloid, an adhesive, a herbicide, a fertilizer, a thickening agent, a sequestering agent, a thixotropic agent, a surfactant, a further antimicrobial compound, a detergent, a preservative, a spreading agent, a filler, a spray oil, a flow additive, a mineral substance, a solvent, a dispersant, an emulsifier, a wetting agent, a stabiliser, an antifoaming agent, a buffering agent, an UV-absorber and an antioxidant.

19. A composition according to claim 16, wherein the amount of natamycin is in a range from 0.005 g/l to about 100 g/l and the amount of the at least one antifungal compound from the family of imidazole fungicides is in a range from about 0.0001 g/l to about 2000 g/l.

20. A kit comprising natamycin and at least one antifungal compound from the family of imidazole fungicides selected from the group consisting of cyazofamid, fenamidone, fenapanil, glyodin, isovaledione, pefurazoate and triazoxide.

21. A method for protecting a product against fungi by treating the product with natamycin and at least one antifungal compound from the family of imidazole fungicides selected from the group consisting of cyazofamid, fenamidone, fenapanil, glyodin, isovaledione, pefurazoate and triazoxide.

22. A method according to claim 21, wherein the product is treated with a composition comprising natamycin and said at least one antifungal compound.

23. A method according to claim 21, wherein the product is at least one selected from the group consisting of a food product, a feed product, a pharmaceutical product, a cosmetic product and an agricultural product.

24. A method according to claim 23, wherein the product is an agricultural product.

25. A method according to claim 24, wherein the product is treated post-harvest.

26. A product comprising natamycin and at least one antifungal compound from the family of imidazole fungicides selected from the group consisting of cyazofamid, fenamidone, fenapanil, glyodin, isovaledione, pefurazoate and triazoxide.

27. A product according to claim 26, wherein the product is selected from the group consisting of a food product, a feed product, a pharmaceutical product, a cosmetic product and an agricultural product.

28. A product according to claim 26, wherein the product is an agricultural product.
